(19) United States
(12) Patent Application Publication
(10) Pub. No.: US 2018/0132503 A1
(43) Pub. Date: May 17, 2018

(54) PROCESS FOR PRODUCING A LIQUID EXTRACT, PROCESS FOR PRODUCING COFFEE WITH REDUCED BITTERNESS, PROCESS FOR PRODUCING TEA, AND PROCESS FOR PRODUCING A LIQUID EXTRACT WHICH INCLUDES PYRAZINES

(71) Applicant: The Coca-Cola Company, Atlanta, GA (US)

(72) Inventors: Akira WATANABE, Tokyo-to (JP); Machiko NAGAYASU, Tokyo-to (JP); Yoshihisa TACHIBANA, Tokyo-to (JP)

(21) Appl. No.: 15/574,403

(22) PCT Filed: Oct. 1, 2015
(86) PCT No.: PCT/US2015/053470

§ 371 Date: Nov. 15, 2017

(30) Foreign Application Priority Data
May 18, 2015 (JP) 2015-101139
May 21, 2015 (JP) 2015-103712

(51) Int. Cl. A23F 3/34; A23F 5/26; A47J 31/00; A47J 31/44

(52) U.S. Cl. CPC A23F 3/34; A47J 31/44; A47J 31/002; A23F 5/26

(57) ABSTRACT

To offer a process for producing tea and a process for producing a liquid extract including pyrazines. A process for producing tea, which includes extracting a liquid extract from barley tea starting material under conditions of pressure, where at least 20 wt % of the barley tea starting material has a particle size of less than 1700 μm. A process for producing a liquid extract including pyrazines, which includes extracting a liquid extract from barley under temperature conditions of at least 100° C., and in extracting the liquid extract, the liquid extract is extracted from the barley under conditions of pressure.

### TECHNICAL FIELD

The present application relates generally to extraction techniques, and relates to a process for producing a liquid extract, process for producing coffee with reduced bitterness, process for producing tea and a process for producing a liquid extract which includes a pyrazine.

### BACKGROUND OF THE INVENTION

When producing a coffee drink for example, hot water is poured into ground coffee beans in an extraction device, and a liquid extract is extracted (see, for example, JP 2005-16969 A and JP 3827079 B). Similarly, when producing black tea, barley tea, green tea or oolong tea, hot water, etc., is poured into tea leaves, and a liquid extract is extracted (see, for example, JP 2003-79350 A; JP 2014-18181 A; JP 4168260 B; and Hiroyuki Suganuma, et al., “The Blood Fluidity Improving Action of Pyrazines Which Are Favor Constituents of The Barley Tea”, Aroma Research, 2002, Vol. 3, No. 10, pp. 38-41). The step of extracting these drinks is a step which has an important effect on the taste and aroma of the drinks.

### SUMMARY OF THE INVENTION

The size of the ground plant starting material used in producing RTD (ready to drink) drinks needs to consider the ease of stable production on an industrial scale, and therefore, generally is rougher than that used in producing non-RTD drinks. Consequently, the percentage yield of the liquid extract may be lowered, or production time may become long. In addition, if production time becomes long, astringency and off flavors increase, and there is the danger that desirable properties will be adversely affected. Therefore, a process which enables efficient extraction of liquid extract, etc., irrespective of the size of the ground plant starting material, is required. Thus, the object of the present invention is to offer a process for producing liquid extract which enables efficient production of a liquid extract, a process for producing coffee with reduced bitterness, a process for producing tea and a process for producing a liquid extract which includes pyrazines.

In extracting a liquid extract in the aforementioned process for producing a liquid extract, a pressure of at least 0.03 MPa in addition to atmospheric pressure can be added inside the extraction device.

In extracting a liquid extract from the aforementioned process for producing a liquid extract, treatment liquid at 90° C. or more can be poured onto the plant starting material. Alternatively, treatment liquid at least at 90° C. and no more than 150° C., can be poured onto the plant starting material in extracting the liquid extract. As another alternative, pressure can be applied such that the treatment liquid does not boil in extracting the liquid extract.

In extracting a liquid extract from the aforementioned process for producing a liquid extract, treatment liquid at no more than 60° C. can be poured onto the plant starting material. In addition, in extracting a liquid extract, treatment liquid at least 20° C. and no more than 60° C., can be poured onto the plant starting material.

In the aforementioned process for producing a liquid extract, the plant starting material can be coffee beans.

And the embodiments of the present invention also offer a process for producing coffee with reduced bitterness, which includes pouring treatment liquid at no more than 60° C. onto coffee beans under conditions of pressure, and extracting a liquid extract from the coffee beans, where at least 50 wt % of the coffee beans have a particle size of less than 1000 μm.

In the aforementioned process for producing coffee with reduced bitterness, at least 70 wt % of the coffee beans can have a particle size of less than 1000 μm.

In extracting a liquid extract from the aforementioned process for producing coffee with reduced bitterness, a pressure of at least 0.03 MPa in addition to atmospheric pressure can be applied inside the extraction device. In addition, in extracting a liquid extract, treatment liquid at least at 20° C. and no more than 60° C. can be poured onto the coffee beans.

The embodiments of the present invention further offer a process for producing tea, which includes extracting a liquid extract from barley tea starting material under conditions of pressure, where at least 20 wt % of the barley tea starting material has a particle size of less than 1700 μm.

In extracting a liquid extract from the aforementioned process for producing tea, a pressure of at least 0.03 MPa in addition to atmospheric pressure can be added inside the extraction device.

In extracting a liquid extract from the aforementioned process for producing tea, treatment liquid at 90° C. or more can be poured onto barley tea starting material. In addition, in extracting a liquid extract, treatment liquid at least at 90° C. and no more than 150° C. can be poured onto barley tea starting material. In addition in extracting a liquid extract, pressure can be applied inside the extraction device such that the treatment liquid does not boil.

In the aforementioned process for producing tea, the tea that is produced can be barley tea or a tea blend. In addition, in the aforementioned process for producing tea, the barley tea starting material can include unground barley tea starting material.

The embodiments of the present invention further offer a process for producing a liquid extract which includes pyrazines, which includes extracting a liquid extract from barley under temperature conditions of at least 100° C., where, in extracting a liquid extract, the liquid extract is extracted from barley under conditions of pressure.

In the aforementioned extraction of a liquid extract which includes pyrazines, the barley can include unground barley. In addition, in the aforementioned extraction of a liquid extract which includes pyrazines, a pressure of at least 0.03 MPa in addition to atmospheric pressure can be applied inside the extraction device.

In the aforementioned extraction of a liquid extract which includes pyrazines, treatment liquid at 100° C. or more can be poured onto barley. In addition, in extracting a liquid extract, treatment liquid at least at 100° C. and no more than 150° C. can be poured onto barley. Moreover, in extracting a liquid extract, pressure can be applied inside the extraction device such that treatment liquid does not boil.

In the aforementioned extraction of a liquid extract which includes pyrazines, 2,3,5-trimethylpyrazine can be extracted.

With the present invention it is possible to offer a process for producing a liquid extract, a process for producing coffee with reduced bitterness, a process for producing tea and a process for producing a liquid extract which includes pyrazines.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic drawing of a system for producing a liquid extract according to a first embodiment of the present invention.

FIG. 2 is a schematic drawing of the extraction device according to the first embodiment of the present invention.

FIG. 3 is a graph showing the relationship between the weight of liquid extract and the percentage yield of dry matter according to Example 1 of the first embodiment of the present invention.

FIG. 4 is a graph showing the relationship between the weight of liquid extract and percentage yield of dry matter according to Example 2 of the first embodiment of the present invention.

FIG. 5 is a graph showing the relationship between the weight of liquid extract and percentage yield of dry matter according to Example 3 of the first embodiment of the present invention.

FIG. 6 is a graph showing the relationship between the weight of liquid extract and percentage yield of dry matter according to Example 4 of the first embodiment of the present invention.

FIG. 7 is a chart showing coffee taste, etc., according to Example 5 of the first embodiment of the present invention.

FIG. 8 is a graph of percentage yield of dry matter in the liquid extract according to Example 1 of the second embodiment of the present invention.

FIG. 9 is a chart showing coffee taste, etc., according to Example 2 of the second embodiment of the present invention.

FIG. 10 is a graph showing the constituents contained in the liquid coffee extract according to Example 3 of the first embodiment of the present invention.

FIG. 11 is a graph showing the relationship between the weight of liquid extract and percentage yield of dry matter according to Example 1 of the third embodiment of the present invention.

FIG. 12 is a graph showing the relationship between the weight of liquid extract and percentage yield of dry matter according to Example 2 of the third embodiment of the present invention.

FIG. 13 is a graph showing the relationship between the weight of liquid extract and percentage yield of dry matter according to Example 3 of the third embodiment of the present invention.

FIG. 14 is a graph showing the relationship between the weight of liquid extract and percentage yield of dry matter according to Example 1 of the fourth embodiment of the present invention.

FIG. 15 is a table showing the quantity of extracted pyrazines according to Example 2 of the fourth embodiment of the present invention.

### DETAILED DESCRIPTION

Embodiments of the present invention are described below. In the descriptions of the drawings below, components which are the same or analogous are represented by the same or analogous symbols. However, the drawings are schematic. Therefore, the specific dimensions thereof, etc., should be judged with reference to the descriptions below. In addition, there are of course also components with dimensional relationships or ratios between them which differ from those in the drawings.

### First Embodiment

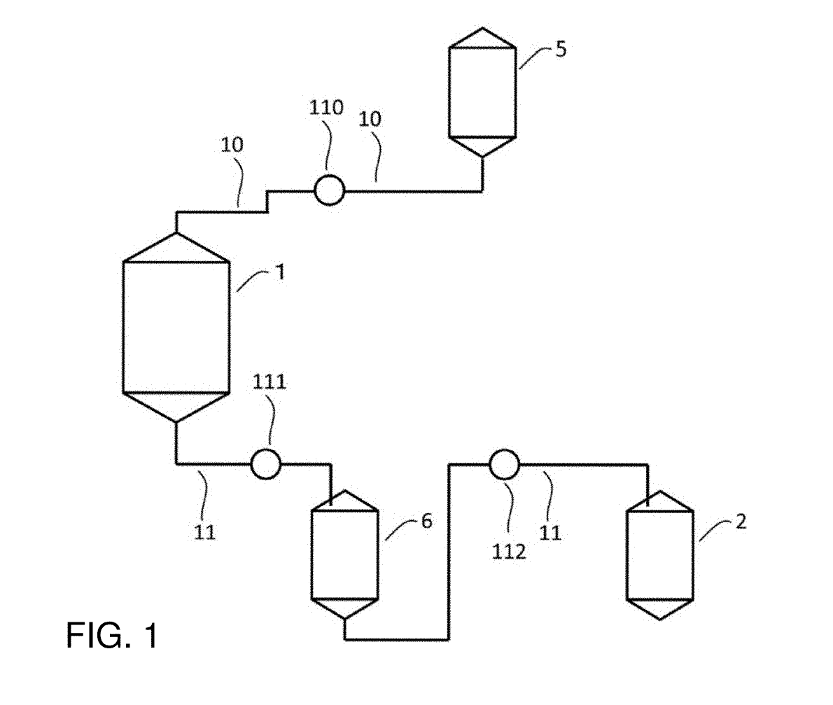

A process for producing a liquid extract according to the first embodiment of the present invention includes extracting a liquid extract from plant starting material under conditions of pressure, where at least 70 wt % of the plant starting material has a particle size of less than 1000 μm. For example, a process for producing a liquid extract according to a first embodiment of the present invention can be carried out by a liquid extract production system such as that shown in FIG. 1. The extract production system is provided with an extraction device (1) which extracts a liquid extract from plant starting material, and a treatment liquid tank (5) which is connected to the extraction device (1) via a flow path (10), and stores treatment liquid supplied to the extraction device (1), and a liquid extract tank (2) which is connected to the extraction device (1) via a flow path (11) and stores the liquid extract extracted by the extraction device (1).

The treatment liquid tank (5) stores the treatment liquid used when the extraction device (1) extracts a liquid extract from plant starting material. The treatment liquid is, for example, hot water. The hot water can be pure water, natural water, or deoxygenated water, etc., and it can include solutes. Flow path (10) is, for example, a pipe. Flow path (10) has a liquid transfer pump (110) for transferring treatment liquid from the treatment liquid tank (5) to the extraction device (1). In addition, flow path (10) can have a heat exchanger, etc., in order to control the temperature of the treatment liquid.

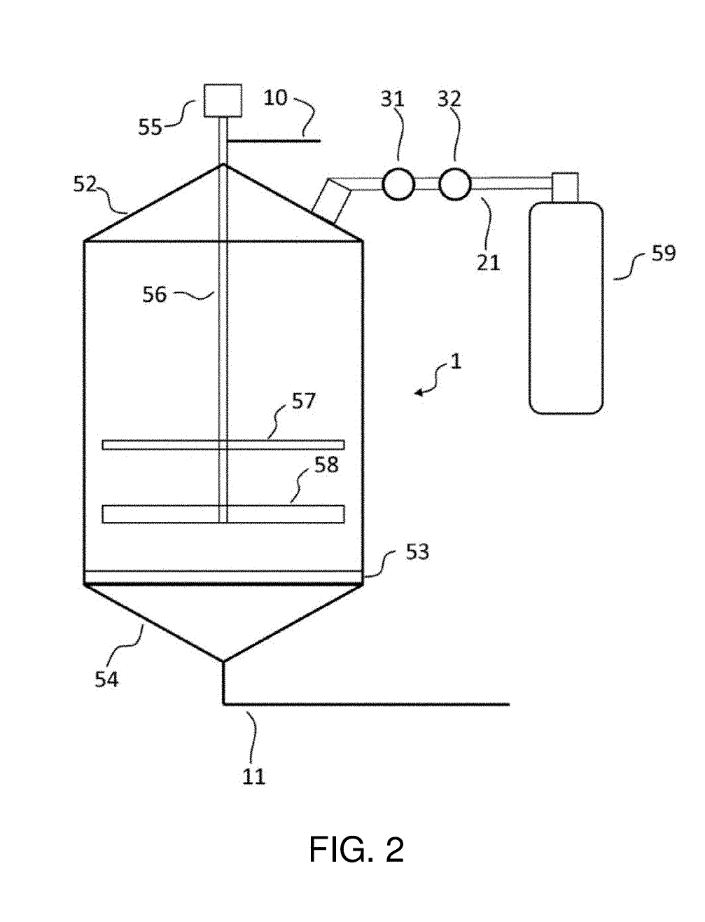

As indicated in FIG. 2, for example, the extraction device (1) is provided with a cylindrical barrel component (51), and an upper cap component (52) which covers the upper opening of the barrel component (51), and a filter (53) which covers the lower opening of the barrel component (51), and a lower cap component (54) which covers the lower opening of the barrel component (51) via the filter (53). The upper cap component (52) and lower cap component (54) close the upper opening and the lower opening of the barrel component (51), respectively. By this means, pressure can be applied to the space inside the extraction device (1) surrounded by the barrel component (51), the upper cap component (52), and the lower cap component (54).

The extraction device (1) is further provided with a rotating shaft (56) inserted into the inside of the barrel component (51) from the upper cap component (52). The rotating shaft (56) has rotating fins (58) and rotating shower nozzles (57). The rotating shower nozzles (57) are connected to treatment liquid flow path (10). A vertically moving rotation drive component (55) is connected to the rotating shaft (56). The rotating shaft (56) can be rotated by the vertically moving rotation drive component (55), and can also move up and down parallel to the side wall of the barrel component (51). The rotating fins (58) and the rotating shower nozzles (57) rotate inside the barrel component (51) accompanying the rotation of the rotating shaft (56). In addition, the rotating fins (58) and the rotating shower nozzles (57) move up and down inside the barrel component (51) accompanying the up and down movement of the rotating shaft (56).

A pressurized gas tank (59) is connected to the extraction device (1) via piping (21). The pressure inside the extraction device (1) can be raised and lowered by sending pressurizing gas into the extraction device (1) from the pressurized gas tank (59). As pressurizing gas, air and nitrogen gas, etc., can be employed. The piping (21) has a pressure sensor (31) and a valve (32). The pressure added to the atmospheric pressure inside the extraction device (1) can be measured by the pressure sensor (31). In addition, the pressure added to the atmospheric pressure inside the extraction device (1) can be regulated by a valve (32). For example, a pressure of at least 0.03 MPa and no more than 0.4 MPa in addition to atmospheric pressure is applied inside the extraction device (1).

As an example of the plant starting material of the liquid extract, for example, ground coffee beans are placed on a filter (53). At least 10 wt % of coffee beans have a particle size of less than 0.3 μm, at least 70 wt %, preferably at least 75 wt %, at least 80 wt % or at least 85 wt %, or at least 85 wt % have a particle size of less than 1000 μm.

And after placing the plant starting material on a filter (53), pressure is applied inside the extraction device (1) from the pressurized gas tank (59). For example, when atmospheric pressure is 0.1 MPa, and a pressure of 0.03 MPa to 0.4 MPa is added from the pressurized gas tank (59), the pressure inside the extraction device (1) becomes 0.13 to 0.5 MPa. The range of pressure is not restricted to these figures; and, for example, pressure can be applied to the extent that the treatment liquid and liquid extract do not boil inside the extraction device (1). Permeation of treatment liquid into plant starting material such as coffee beans can be sped up by having a high pressure inside the extraction device (1). In addition, volatilization of fragrance constituents can be hindered by increased pressure.

Treatment liquid is poured onto the coffee beans from the rotating shower nozzles (57) from top to bottom. Shower speed is 0.5 to 3.3 m/hr, and preferably 1.4 to 3.3 m/hr, as linear velocity. The temperature of the treatment liquid is, for example, at least 90° C., or at least 100° C. and no more than 150° C. When the intention is to suppress the bitterness of the coffee produced, the temperature of the treatment liquid is, for example, at least 90° C. and no more than 130° C., no more than 120° C., no more than 110° C., or no more than 100° C. When boiling is hindered by increased pressure, the temperature of the treatment liquid can be made higher. By pouring the treatment liquid onto the coffee beans during rotation of the rotating shower nozzles (57), the treatment liquid is poured evenly onto the coffee beans. The rotating fins (58) are used in order to stir the coffee beans immersed in treatment liquid.

The liquid extracted from the coffee beans after pouring on the treatment liquid passes through a filter (53), and is stored in the lower cap component (54) which functions as a receptacle for the liquid extract. The liquid extract stored in the lower cap component (54) is transferred to the buffer tank (6) shown in FIG. 1, for temporarily storing the liquid extract, via flow path (11). Flow path (11) can have a liquid transfer pump (111) for transferring the liquid extract from the extraction device (1) to the buffer tank (6), the liquid extract can also be transferred from the extraction device (1) to the buffer tank (6) under gravity or pressure, etc. Flow path (11) linking the extraction device (1) and the buffer tank (6) can also have a heat exchanger, etc., in order to control the temperature of the treatment liquid.

The liquid extract stored in the buffer tank (6) is transferred to the liquid extract tank (2) via flow path (11). The liquid extract can be used, for example, in drinks, as starting material for drinks used diluted for drinking, and as a concentrate for drinks which are diluted for drinking. Flow path (11) has a liquid transfer pump (112) for transferring the liquid extract from the buffer tank (6) to the liquid extract tank (2). In addition, flow path (11) linking the buffer tank (6) and the liquid extract tank (2) can have a heat exchanger, etc., in order to control the temperature of the treatment liquid.

### Example 1 of the First Embodiment

A mesh with openings of 1000 μm (stainless steel experimental screen, JIS Z 8801, product code: 91-0729-3, Hayashi Kagaku Co., Ltd.) was used. In addition, 25 kg of roasted ground coffee beans 15 wt % of which remained on the mesh when screened though this mesh, and 25 kg of roasted ground coffee beans 15 wt % of which remained on the mesh were used.

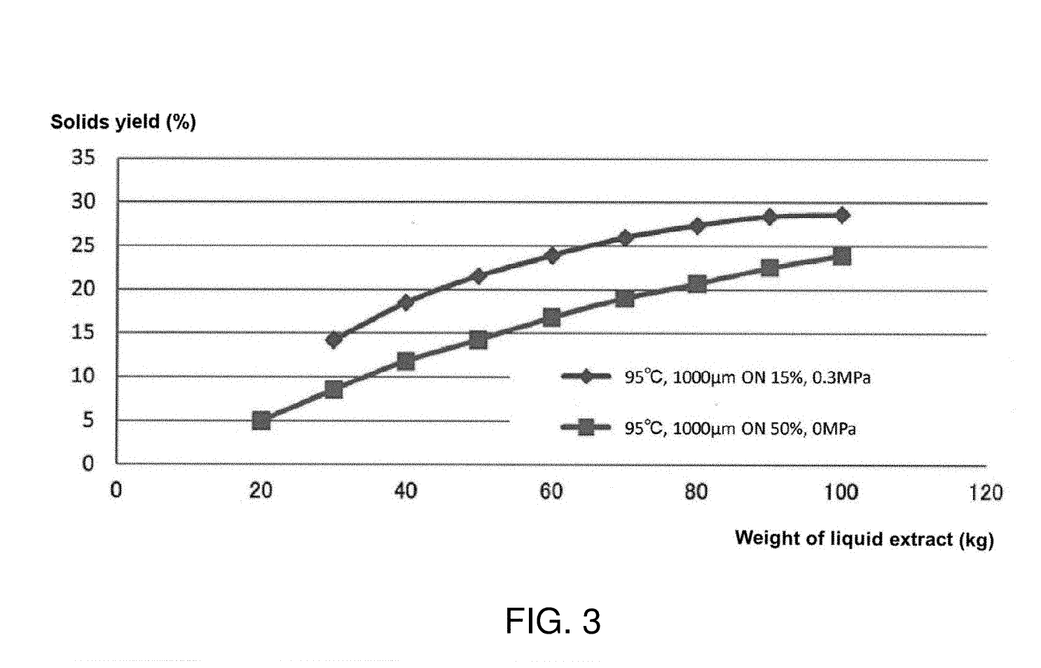

As shown in FIG. 3, 100 kg of liquid extract was obtained by pouring hot water at 95° C. onto roasted ground coffee beans 50 wt % of which remained on the mesh, at atmospheric pressure. The dry matter content of the resulting liquid extract was measured by a digital refractometer (Atago Co., Ltd., RX-5000a). Percentage yield of dry matter obtained by dividing the solids content of the resulting liquid extract by 25 kg was 23.96%.

In addition, 100 kg of liquid extract was obtained by pouring hot water at 95° C. onto roasted ground coffee beans 15 wt % of which remained on the mesh, at a pressure of 0.3 MPa in addition to atmospheric pressure. Solids yield obtained by dividing the dry matter content of the resulting liquid extract by 25 kg was 28.68%.

The results of Example 1 indicate that solids yield is higher the finer the particle size of the coffee beans. The results of Example 1 also indicate that solids yield is higher the higher the pressure during extraction of the coffee beans.

### Example 2 of the First Embodiment

A mesh with openings of 1000 μm as in Example 1 was used. In addition, 25 kg of roasted ground coffee beans 50 wt % of which remained on the mesh when screened through this mesh, and 25 kg of roasted ground coffee beans 15 wt % of which remained on the mesh were used.

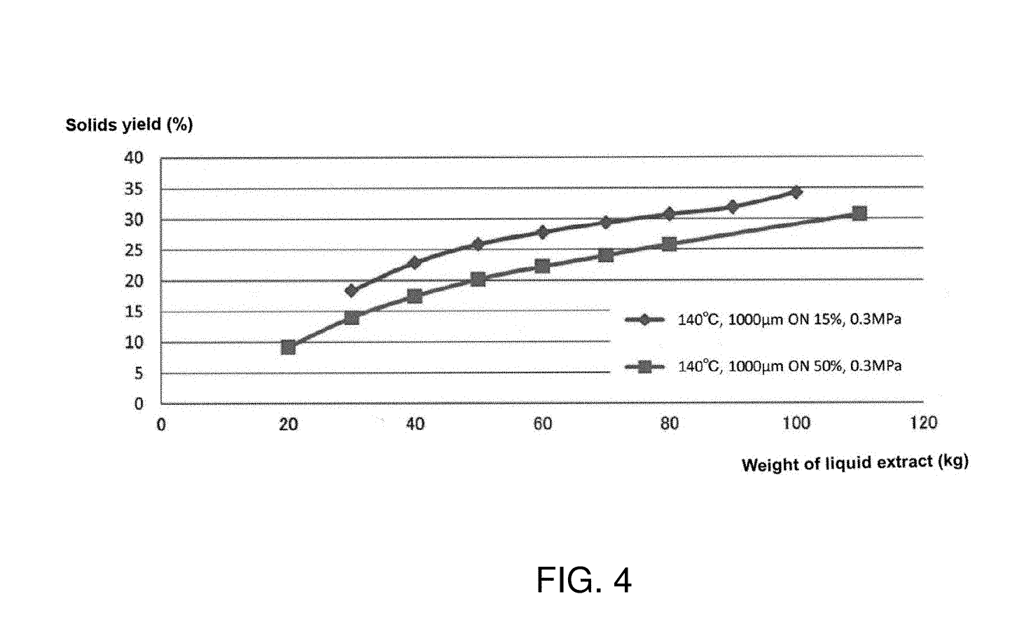

As shown in FIG. 4, 100 kg of liquid extract was obtained by pouring hot water at 140° C. onto roasted ground coffee beans 50 wt % of which remained on the mesh, at a pressure of 0.3 MPa in addition to atmospheric pressure. The solids yield obtained by dividing the solids content of the resulting liquid extract by 25 kg was 30.71%.

In addition, 100 kg of liquid extract was obtained by pouring hot water at 140° C. into roasted ground coffee beans 15 wt % of which remained on the mesh, at a pressure of 0.3 MPa in addition to atmospheric pressure. The solids yield obtained by dividing the solids content of the resulting liquid extract by 25 kg was 34.24%.

The results of Example 2 indicate that the solids yield is higher the finer the particle size of the coffee beans. In addition, comparison with the results of Example 1 indicates that the solids yield is higher the higher the temperature of the treatment liquid.

### Example 3 of the First Embodiment

A mesh with openings of 1000 μm as in Example 1 was used. In addition, 25 kg of roasted ground coffee beans 50 wt % of which remained on the mesh when screened through this mesh, 50 kg of roasted ground coffee beans 40 wt % of which remained on the mesh (2 sets of 25 kg), 25 kg of roasted ground coffee beans 30 wt % of which remained on the mesh, 25 kg of roasted ground coffee beans 25 wt % of which remained on the mesh, and 25 kg of roasted ground coffee beans 15 wt % of which remained on the mesh were used.

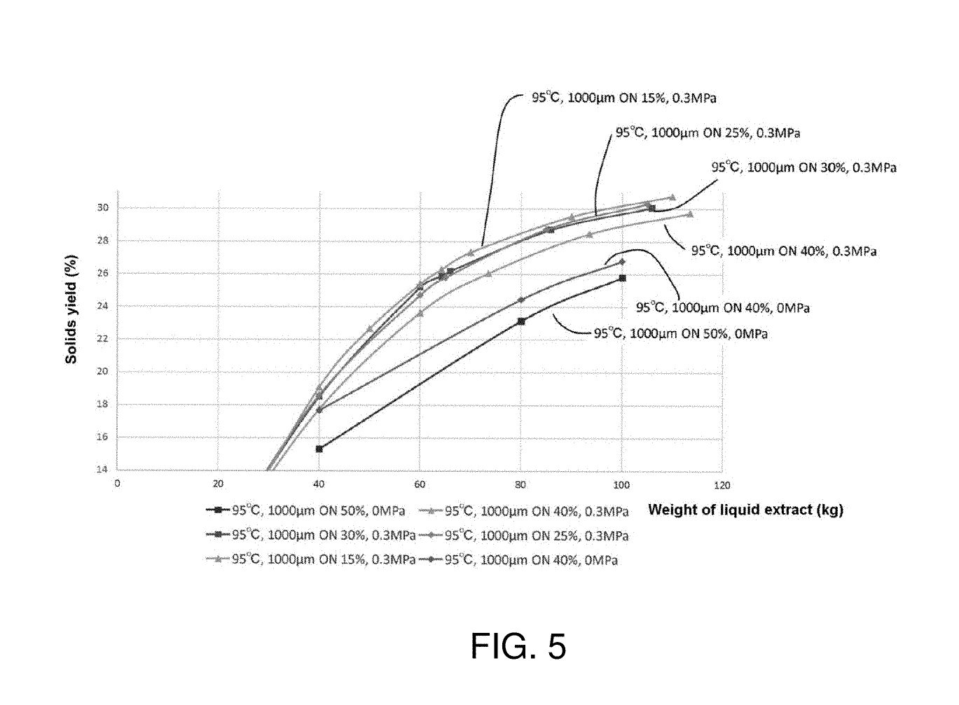

As shown in FIG. 5, 100 kg of liquid extract was obtained by pouring hot water at 95° C. onto roasted ground coffee beans 50 wt % of which remained on the mesh, at atmospheric pressure. The solids yield obtained by dividing the solids content of the resulting liquid extract by 25 kg was 24.52%.

In addition, 100 kg of liquid extract was obtained by pouring hot water at 95° C. onto roasted ground coffee beans 40 wt % of which remained on the mesh, at atmospheric pressure. The solids yield obtained by dividing the solids content of the resulting liquid extract by 25 kg was 26.80%.

Moreover, 100 kg of liquid extract was obtained by pouring hot water at 95° C. onto roasted ground coffee beans 40 wt % of which remained on the mesh, at a pressure of 0.3 MPa in addition to atmospheric pressure. The solids yield obtained by dividing the solids content of the resulting liquid extract by 25 kg was 28.94%.

100 kg of liquid extract was obtained by pouring hot water at 95° C. onto roasted ground coffee beans 30 wt % of which remained on the mesh, at a pressure of 0.3 MPa in addition to atmospheric pressure. The solids yield obtained by dividing the solids content of the resulting liquid extract by 25 kg was 29.67%.

100 kg of liquid extract was obtained by pouring hot water at 95° C. onto roasted ground coffee beans 25 wt % of which remained on the mesh, at a pressure of 0.3 MPa in addition to atmospheric pressure. The solids yield obtained by dividing the solids content of the resulting liquid extract by 25 kg was 29.91%.

100 kg of liquid extract was obtained by pouring hot water at 95° C. onto roasted ground coffee beans 15 wt % of which remained on the mesh, at a pressure of 0.3 MPa in addition to atmospheric pressure. The solids yield obtained by dividing the solids content of the resulting liquid extract by 25 kg was 30.15%.

The results of Example 3 indicate that solids yield is higher the finer the particle size of the coffee beans. The results of Example 3 also indicate that solids yield is higher the higher the pressure when extracting coffee.

### Example 4 of the First Embodiment

A mesh with openings of 1000 μm as in Example 1 was used. In addition, 25 kg of roasted ground coffee beans 50 wt % of which remained on the mesh when screened through this mesh, 25 kg of roasted ground coffee beans 40 wt % of which remained on the mesh, 25 kg of roasted ground coffee beans 30 wt % of which remained on the mesh, 25 kg of roasted ground coffee beans 25 wt % of which remained on the mesh, and 25 kg of roasted ground coffee beans 15 wt % of which remained on the mesh were used.

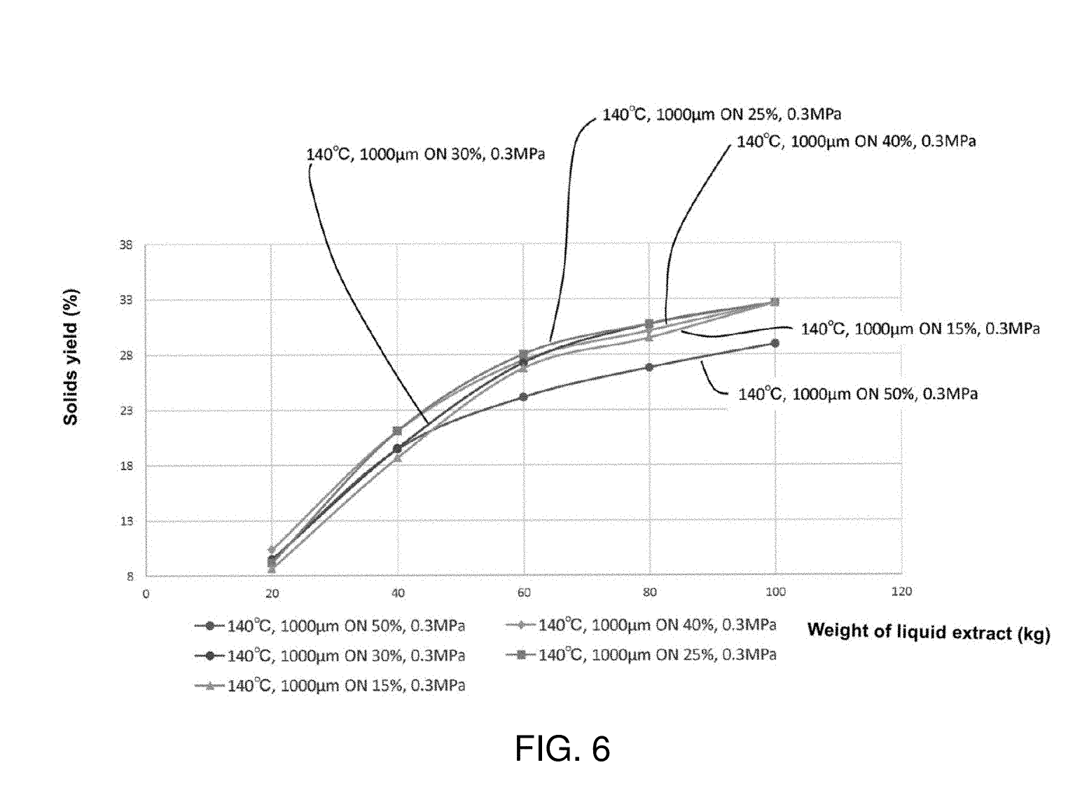

As shown in FIG. 6, 100 kg of liquid extract was obtained by pouring hot water at 140° C. onto roasted ground coffee beans 50 wt % of which remained on the mesh, at a pressure of 0.3 MPa in addition to atmospheric pressure. The solids yield obtained by dividing the solids content of the resulting liquid extract by 25 kg was 28.92%.

100 kg of liquid extract was obtained by pouring hot water at 140° C. onto roasted ground coffee beans 40 wt % of which remained on the mesh, at a pressure of 0.3 MPa in addition to atmospheric pressure. The solids yield obtained by dividing the solids content of the resulting liquid extract by 25 kg was 32.64%.

100 kg of liquid extract was obtained by pouring hot water at 140° C. onto roasted ground coffee beans 30 wt % of which remained on the mesh, at a pressure of 0.3 MPa in addition to atmospheric pressure. The solids yield obtained by dividing the solids content of the resulting liquid extract by 25 kg was 32.64%.

In addition, 100 kg of liquid extract was obtained by pouring hot water at 140° C. onto roasted ground coffee beans 25 wt % of which remained on the mesh, at a pressure of 0.3 MPa in addition to atmospheric pressure. The solids yield obtained by dividing the solids content of the resulting liquid extract by 25 kg was 32.64%.

Moreover, 100 kg of liquid extract was obtained by pouring hot water at 140° C. onto roasted ground coffee beans 15 wt % of which remained on the mesh, at a pressure of 0.3 MPa in addition to atmospheric pressure. The solids yield obtained by dividing the solids content of the resulting liquid extract by 25 kg was 32.64%.

The results of Example 4 indicate that the solids yield is higher the finer the particle size of the coffee beans.

### Example 5 of the First Embodiment

Coffee obtained by pouring hot water at 95° C. onto roasted ground coffee beans 40 wt % of which remained on the mesh, at a pressure of 0.3 MPa in addition to atmospheric pressure, and coffee obtained by pouring hot water at 95° C. onto roasted ground coffee beans 30 wt % of which remained on the mesh, at a pressure of 0.3 MPa in addition to atmospheric pressure, and coffee obtained by pouring hot water at 95° C. onto roasted ground coffee beans 25 wt % of which remained on the mesh, at a pressure of 0.3 MPa in addition to atmospheric pressure, and coffee obtained by pouring hot water at 95° C. onto roasted ground coffee beans 15 wt % of which remained on the mesh, at a pressure of 0.3 MPa in addition to atmospheric pressure, and coffee obtained by pouring hot water at 95° C. onto roasted ground coffee beans 50 wt % of which remained on the mesh, at atmospheric pressure, were subjected to sensory evaluation by 8 panel members with experience of evaluating coffee.

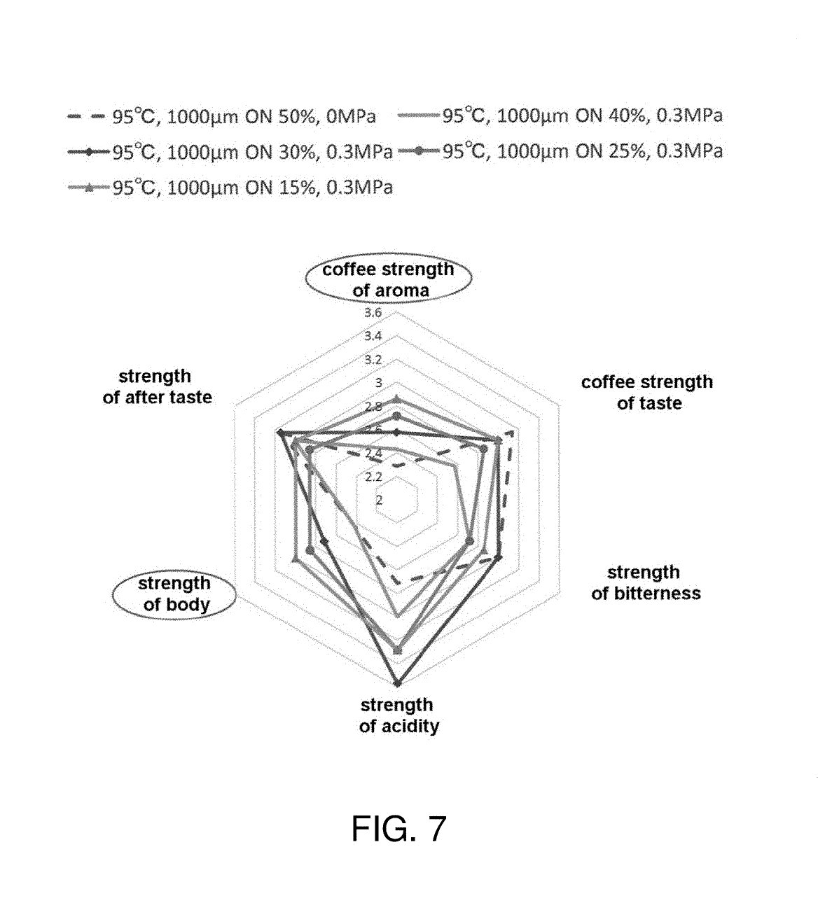

As shown in FIG. 7, it was evaluated that coffee obtained by pouring hot water at 95° C. onto roasted ground coffee beans at a pressure of 0.3 MPa in addition to atmospheric pressure, is stronger in aroma and body than coffee obtained by pouring hot water at 95° C. onto roasted ground coffee beans at atmospheric pressure, and is highly fragrant coffee. Moreover, it was evaluated that coffee beans with a fine particle size gave a stronger aroma and body.

### Second Embodiment

The process for producing coffee with reduced bitterness according to the second embodiment of the present invention includes pouring treatment liquid at no more than 60° C. onto coffee beans under conditions of pressure, and extracting a liquid extract from the coffee beans, where at least 50 wt %, and preferably at least 60%, or at least 70 wt % of coffee beans, have a particle size of less than 1000 μm. The process for producing coffee with reduced bitterness according to the second embodiment of the present invention can also be carried out by a liquid extract production system as shown in FIG. 1, for example; however, the fact that the temperature of the treatment liquid is 20° C. to 60° C., and preferably 25-55° C., or 30° C. to 50° C., differs from the first embodiment. The other features are the same as in the first embodiment; for example, a pressure of at least 0.03 MPa and no more than 0.4 MPa in addition to atmospheric pressure is applied inside the extraction device (1).

At atmospheric pressure, treatment liquid at no more than 60° C. takes time to impregnate coffee beans, and effective extraction is not possible. By contrast, with a process for producing coffee with reduced bitterness according to the second embodiment, coffee can be extracted efficiently. In addition, with a process for producing coffee according to the second embodiment, it is possible to produce coffee having a characteristic flavor, with little bitterness, and with a strong aroma and sweetness.

### Example 1 of the Second Embodiment

A mesh with openings of 1000 μm (stainless steel experimental screen, JIS Z 8801, product code: 91-0729-3, Hayashi Kagaku Co., Ltd.) was used. In addition, roasted ground coffee beans 25 wt % of which remained on the mesh when screened through this mesh were used.

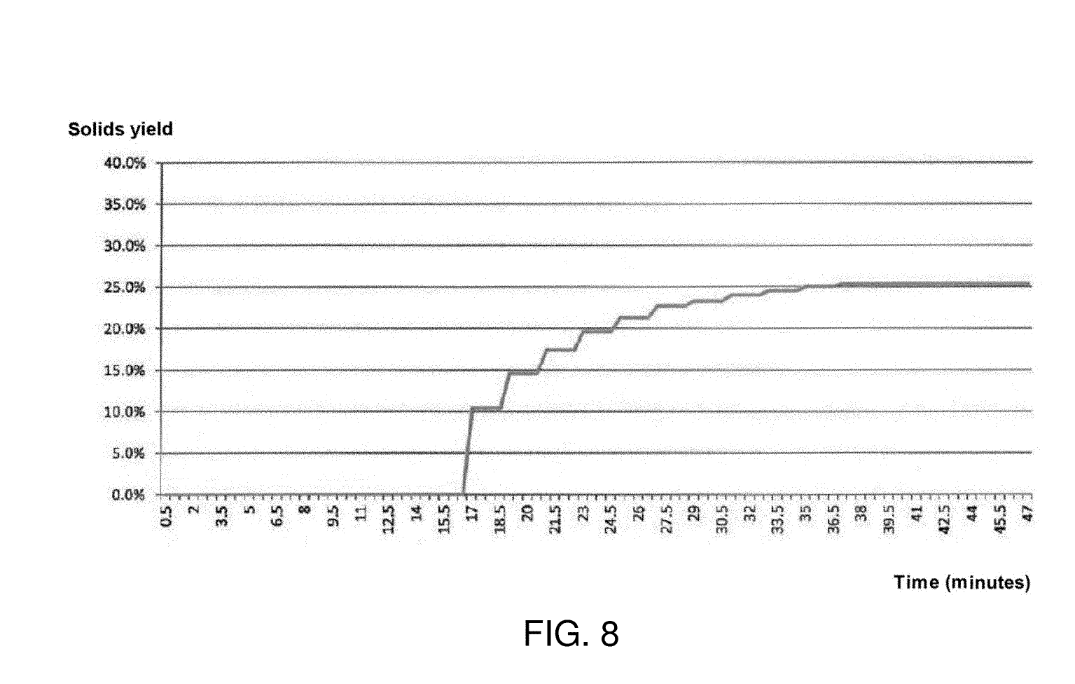

As shown in FIG. 8, a liquid extract was obtained by pouring hot water at 30° C. onto roasted ground coffee beans 25 wt % of which remained on the mesh, at a pressure of 0.3 MPa in addition to atmospheric pressure. The percentage yield of solids in the resulting liquid extract was ca. 25%. By contrast, when hot water at 30° C. was poured onto roasted ground coffee beans 25 wt % of which remained on the mesh, at atmospheric pressure, swelling of the roasted ground coffee beans was incomplete, and extraction was impossible

The results of Example 1 indicate that even with treatment liquid at a low temperature such as 30° C. or less, effective extraction can be carried out by applying pressure.

### Example 2 of the Second Embodiment

Coffee obtained by pouring hot water at 30° C. onto roasted ground coffee beans 25 wt % of which remained on the mesh, at a pressure of 0.3 MPa in addition to atmospheric pressure, and coffee obtained by pouring hot water at 50° C. onto roasted ground coffee beans 25 wt % of which remained on the mesh, at a pressure of 0.3 MPa in addition to atmospheric pressure, and coffee obtained by pouring hot water at 90° C. onto roasted ground coffee beans 25 wt % of which remained on the mesh, at a pressure of 0.3 MPa in addition to atmospheric pressure, and coffee obtained by pouring hot water at 115° C. onto roasted ground coffee beans 25 wt % of which remained on the mesh, at a pressure of 0.3 MPa in addition to atmospheric pressure, and coffee obtained by pouring hot water at 140° C. onto roasted ground coffee beans 25 wt % of which remained on the mesh, at a pressure of 0.3 MPa in addition to atmospheric pressure, were subjected to sensory evaluation by 10 panel members with experience of evaluating coffee.

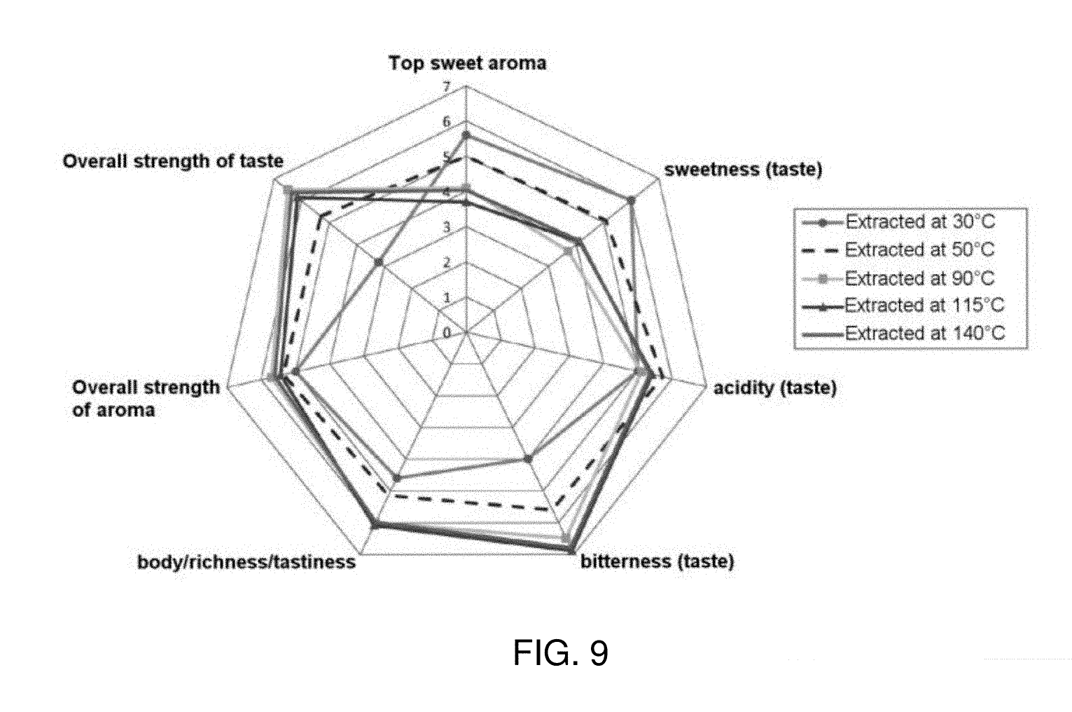

As shown in FIG. 9, it was evaluated that coffee obtained by pouring hot water at 30° C. and 50° C. onto roasted ground coffee beans at a pressure of 0.3 MPa in addition to atmospheric pressure, has a flavor characterized by strong aroma and sweetness, and weak bitterness.

### Example 3 of the Second Embodiment

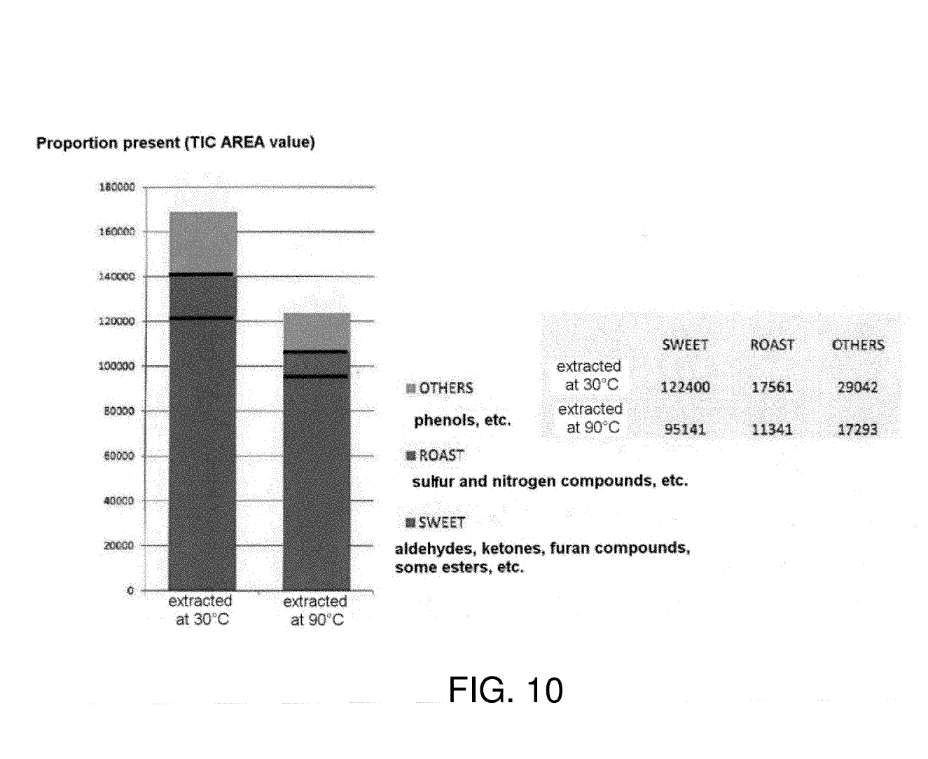

When the constituents of coffee extracted with hot water at 30° C. under increased pressure and the constituents of coffee extracted with hot water at 90° C. at atmospheric pressure in Example 2 were analyzed by gas chromatography mass spectrometry (GC-MS) using the headspace method, as shown in FIG. 10, coffee extracted with hot water at 30° C. under increased pressure showed a rich content of sweetening constituents such as aldehydes, ketones, furan compounds, and some esters.

### Third Embodiment

The process for producing tea according to the third embodiment of the present invention includes extracting a liquid extract from barley tea starting material under conditions of pressure, where at least 20 wt % of the barley tea starting material has a particle size of less than 1700 μm. It should be noted that the barley tea starting material can include unground barley tea starting material. The tea that is produced can be barley tea, or a tea blend of barley tea and other tea constituents. For example, the process for producing tea according to the third embodiment can also be carried out by a liquid extract production system such as that shown in FIG. 1. The pressure applied inside the extraction device (1) and the temperature of the treatment liquid are also the same as in the first embodiment, for example, in extracting a liquid extract, a pressure of at least 0.03 MPa in addition to atmospheric pressure is applied inside the extraction device (1). A pressure such that the treatment liquid does not boil can be applied inside the extraction device (1). In addition, for example, in extracting a liquid extract, and treatment liquid of at least 90° C., or at least 100° C. and no more than 150° C. is poured onto barley tea starting material.

In the prior process for producing tea, percentage yield of solids is poor because the barley tea starting material is not ground, and pressure is not applied during extraction. Moreover, if a liquid extract is extracted from ground barley tea starting material under atmospheric pressure, the filter (53) inside the extraction device (1) becomes clogged. By contrast, with the process for producing tea according to the third embodiment, clogging of the filter (53) inside the extraction device (1) is suppressed by extracting a liquid extract from ground barley tea starting material under pressure; and it becomes possible to obtain liquid extract with a solids content with high yield, while maintaining intact the natural flavor. Moreover, extraction time also becomes shorter, so that it becomes possible to improve the efficiency of the extraction step.

### Example 1 of the Third Embodiment

A mesh with openings of 1700 μm (stainless steel experimental screen, JIS Z 8801, product code: 91-0726-3, Hayashi Kagaku Co., Ltd.) was used. In addition, 2 sets with 12.5 kg of barley tea starting material 98.8 wt % of which remained on the mesh when screened through this mesh and 12.5 kg of ground barley tea starting material 70.6 wt % of which remained on the mesh, were used.

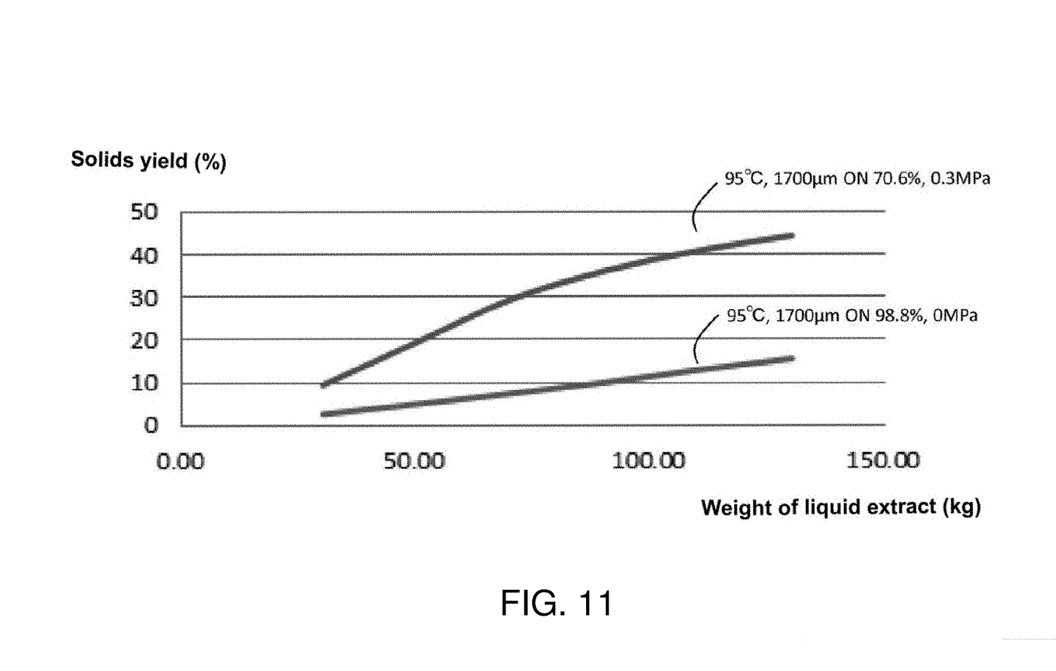

As shown in FIG. 11, 139 kg of liquid extract was obtained by pouring hot water at 95° C. onto barley tea starting material 98.8 wt % of which remained on the mesh, at atmospheric pressure. The solids yield obtained by dividing the solids content of the resulting liquid extract by 12.5 kg was 15.5%.

When hot water at 95° C. was poured onto barley tea starting material 70.6 wt % of which remained on the mesh, at atmospheric pressure, the filter of the extraction device caused clogging, and it was impossible to obtain a liquid extract.

130 kg of liquid extract was obtained by pouring hot water at 95° C. onto barley tea starting material 70.6 wt % of which remained on the mesh, at a pressure of 0.3 MPa in addition to atmospheric pressure. The solids yield obtained by dividing the solids content of the resulting liquid extract by 12.5 kg was 44.2%. This is equivalent to ca. 2.9 times the 15.5% above.

The results of Example 1 indicate that the solids yield is higher the finer the particle size of the barley tea starting material. The results of Example 1 also indicate that the solids yield is higher the higher the pressure when extracting barley tea.

### Example 2 of the Third Embodiment

12.5 kg of barley tea starting material 98.8 wt % of which remained on the mesh when applied to a screen with the same mesh as in Example 1, and 12.5 kg of ground barley tea starting material 70.6 wt % of which remained on the mesh, were used.

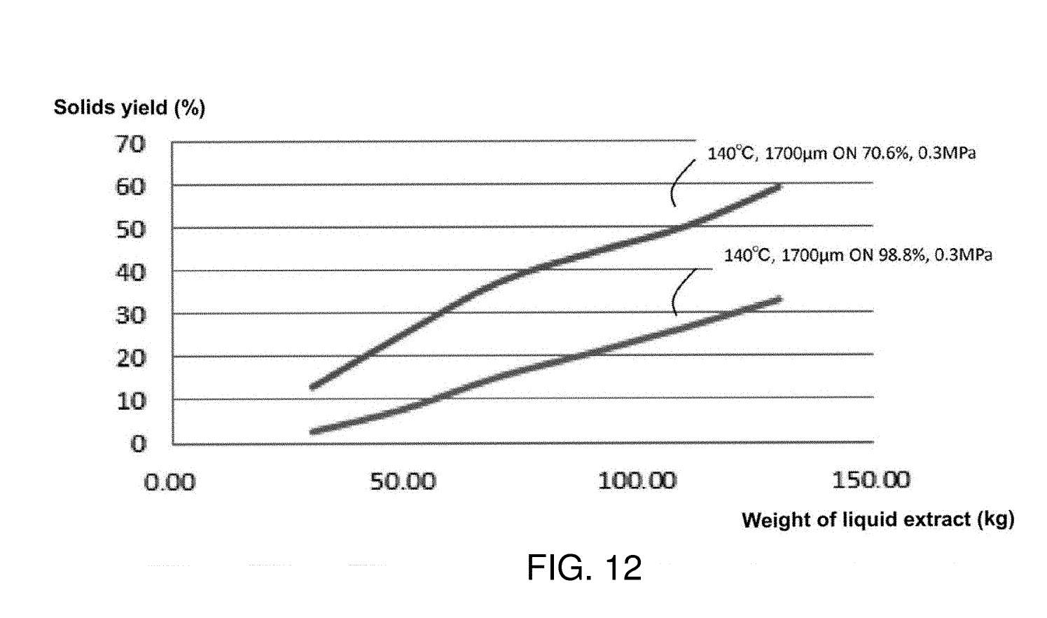

As shown in FIG. 12, 139 kg of liquid extract was obtained by pouring hot water at 140° C. onto barley tea starting material 98.8 wt % of which remained on the mesh, at a pressure of 0.3 MPa in addition to atmospheric pressure. The solids yield obtained by dividing the solids content of the resulting liquid extract by 12.5 kg was 33.1%.

139 kg of liquid extract was obtained by pouring hot water at 140° C. onto barley tea starting material 70.6 wt % of which remained on the mesh, at a pressure of 0.3 MPa in addition to atmospheric pressure. The solids yield obtained by dividing the solids content of the resulting liquid extract by 12.5 kg was 59.2%.

The results of Example 2 indicate that the solids yield is higher the finer the particle size of the barley tea starting material. By comparison with the results of Example 1, the results of Example 2 also indicate that the solids yield is higher the higher the temperature of the treatment liquid when extracting barley tea.

### Example 3 of the Third Embodiment

Two sets of 12.5 kg of ground barley tea starting material 70.6 wt % of which remained on the mesh when applied to a screen with the same mesh as in Example 1, were used.

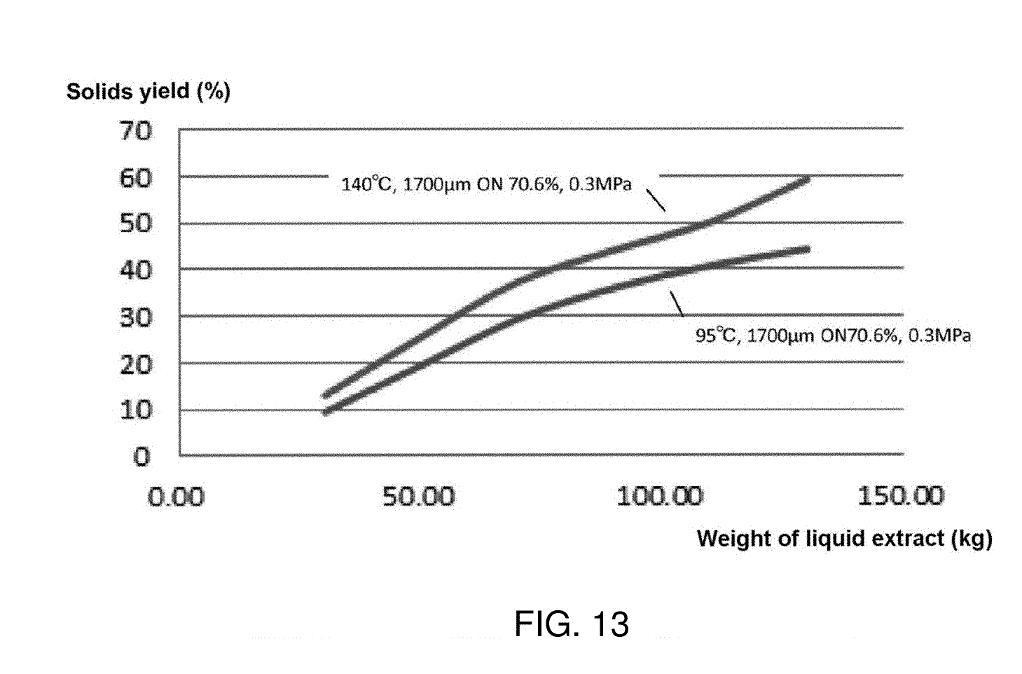

As shown in FIG. 13, 130 kg of liquid extract was obtained by pouring hot water at 95° C. onto barley tea starting material 70.6 wt % of which remained on the mesh, at a pressure of 0.3 MPa in addition to atmospheric pressure. The solids yield obtained by dividing the solids content of the resulting liquid extract by 12.5 kg was 44.2%.

139 kg of liquid extract was obtained by pouring hot water at 140° C. onto barley tea starting material 70.6 wt % of which remained on the mesh, at a pressure of 0.3 MPa in addition to atmospheric pressure. The solids yield obtained by dividing the solids content of the resulting liquid extract by 12.5 kg was 59.2%.

The results of Example 3 indicate that the solids yield is higher the higher the temperature of the treatment liquid when extracting barley tea.

### Fourth Embodiment

The process for producing a liquid extract which includes pyrazines according to the fourth embodiment of the present invention which includes extracting a liquid extract from barley under temperature conditions of at least 100° C., where, in extracting a liquid extract, the liquid extract is extracted from barley under conditions of pressure. Preferably the liquid extract is extracted from barley which included unground barley.

Pyrazines included 2-methylpiperazine, 2,5-dimethylpiperazine, 2-ethylpiperazine, 2,3-dimethylpiperazine, 2-isopropylpyrazine, 2-ethyl-6-methylpyrazine, 2-ethyl-5-methylpyrazine, 2,3,5-trimethylpyrazine, 2-propylpyrazine, 2,6-ethylpyrazine, 2-vinylpyrazine, 2-ethyl-3,6-dimethylpyrazine, 2-isobutylpyrazine, 2,3-dimethyl-5-ethylpyrazine, 2-methyl-6-propylpyrazine, tetramethylpyrazine, 2-methyl-3-propyl-pyrazine, 2-isobutyl-6-methylpyrazine, 2-methyl-6-vinylpyrazine, 3,5-ethyl-2-methylpyrazine, 2-methyl-3-vinylpyrazine, 2-isobutyl-3-methylpyrazine, 3-ethyl-2,5,6-trimethylpyrazine, (Z)-2-(1-propenyl)pyrazine, (E)-2-(1-propenyl)pyrazine, 2-acetylpyrazine, 6,7-dihydro-5H-cyclopentapyrazine, (E)-2-methyl-6-(1-propenyl)pyrazine, 2.5-dimethyl-6,7-dihydro-5H-cyclopentapyrazine, 2-acetyl-6-methylpyrazine, 2-acetyl-5-methylpyrazine, 2-dimethyl-6,7-dihydro-5H-cyclopentapyrazine, 2-(2-furyl)pyrazine and 2-(2-furfuryl)pyrazine,

The chemical structure of 2,3,5-trimethylpyrazine is C7H10N2, having the structure shown below.

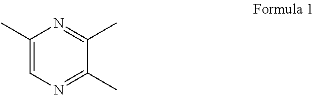

Pyrazines, and especially 2,3,5-trimethylpyrazine, have an aroma which resembles roast nuts when heated, they are constituents naturally present in foods such as barley, and can be employed as fragrances. In addition, in the body, 2,3,5-trimethylpyrazine has been reported to have a favorable effect on blood flow.

Although prior barley tea includes pyrazines, including 2,3,5-trimethylpyrazine, the percentage content is low. By contrast, with a process for producing a liquid extract which includes pyrazines according to the fourth embodiment, pyrazines can be extracted from barley with a high yield. The process for producing a liquid extract which includes pyrazines according to a fourth embodiment of the present invention can also be carried out, for example, by a liquid extract production system such as that shown in FIG. 1. The pressure applied inside the extraction device 1 and the temperature of the treatment liquid are also the same as in the first embodiment, for example, in extracting a liquid extract, a pressure of at least 0.03 MPa and no more than 0.4 MPa in addition to atmospheric pressure is applied inside the extraction device (1). Pressure can also be applied inside the extraction device (1) such that the treatment liquid does not boil. In addition, in extracting a liquid extract, the treatment liquid, for example, at least 100° C., preferably at least 110° C., at least 120° C., or at least 130° C. and no more than 150° C. is poured onto the barley tea starting material.

### Example 1 of the Fourth Embodiment

Two sets of 12.5 kg and 25.0 kg of unground barley tea starting material were used.

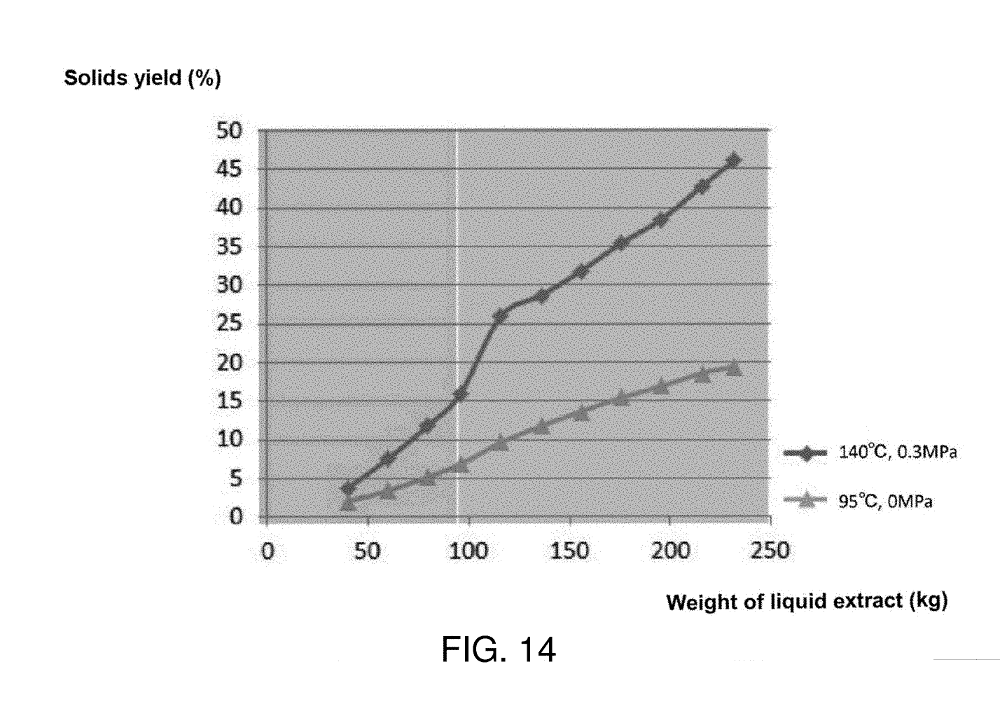

As shown in FIG. 14, 190 kg of liquid extract was obtained by pouring hot water at 95° C. to 25.0 kg of barley tea starting material, at atmospheric pressure. The liquid extract with a solids yield of 16.8% was diluted to give a Brix value of 0.42% as a drinking sample. Moreover, this drinking sample was adjusted to pH 6.5 and then heat sterilized. When a distillate obtained by distilling the drinking sample under conditions of outside temperature 40° C., and decreased pressure 1.5×10-3-3.5×10−3 Pa was extracted with diethyl ether, dehydrated over sodium sulfate, and then the solvent was evaporated off at ambient pressure to make an aroma concentrate and pyrazines were measured by GC-MS/FID (hydrogen flame ionization detector), 2.575 ppm/400 g (0.644 ppm/100 g) was detected; and on measuring 2,3,5-trimethylpyrazine, 0.225 ppm/400 g (0.056 ppm/100 g) was detected.

In order to convert these values to percentage recovery of barley tea starting material, the quantity of pyrazines and the quantity of 2,3,5-trimethylpyrazine in the barley tea starting material were calculated by dividing the ppm of 2,3,5-trimethylpyrazine per 100 g of drinking sample by the quantity (g) of barley tea starting material used per 100 g of drinking sample, and multiplying the result by 100. As a result, the quantity of pyrazines in the barley tea starting material was 25.8 ppm/100 g (barley tea starting material), and the quantity of 2,3,5-trimethylpyrazine was 2.25 ppm/100 g (barley tea starting material).

In addition, 205 kg of liquid extract was obtained by pouring hot water at 140° C. onto 12.5 kg of barley tea starting material, at a pressure of 0.3 MPa in addition to atmospheric pressure. The solids yield in the resulting liquid extract was 40.0%. This liquid extract was diluted to give a Brix value of 0.51%, as a drinking sample. This drinking sample was further adjusted to pH 6.5, and then heat sterilized. When the drinking sample was distilled under conditions of outside temperature 40° C., and decreased pressure 1.5×10-3 to 3.5×10−3 Pa, the resulting distillate was extracted with diethyl ether, and dehydrated over sodium sulfate, and then the solvent was evaporated off at ambient pressure to prepare an aroma concentrate and pyrazines were measured by GC-MS/FID, 5.330 ppm/400 g (1.333 ppm/100 g) is detected on measuring 2,3,5-trimethylpyrazine, 0.425 ppm/400 g (0.106 ppm/100 g) was detected.

On converting these values to percentage recovery in the barley tea starting material by the same process as above, pyrazines were 106.60 ppm/100 g (barley tea starting material), and 2,3,5-trimethylpyrazine was 8.50 ppm/100 g (barley tea starting material).

The results of Example 1 indicate that the percentage yield of pyrazines and 2,3,5-trimethylpyrazine are higher the higher the temperature of the treatment liquid. The results of the example also indicate that the percentage yield of pyrazines and 2,3,5-trimethylpyrazine is higher the higher the pressure when extracting the liquid extract.

### Example 2 of the Fourth Embodiment

Three sets of 25.0 kg of ground barley tea starting material were used. In this connection, ground barley tea starting material is barley tea starting material 70.6 wt % of which remains on the mesh when graded with a mesh with openings of 1700 μm (stainless steel experimental screen, JIS Z 8801, product code: 91-0726-3, Hayashi Kagaku Co., Ltd.).

When hot water at 95° C. was poured onto 25.0 kg of ground barley tea starting material, at atmospheric pressure, the extraction device filter became clogged and it was impossible to obtain a liquid extract.

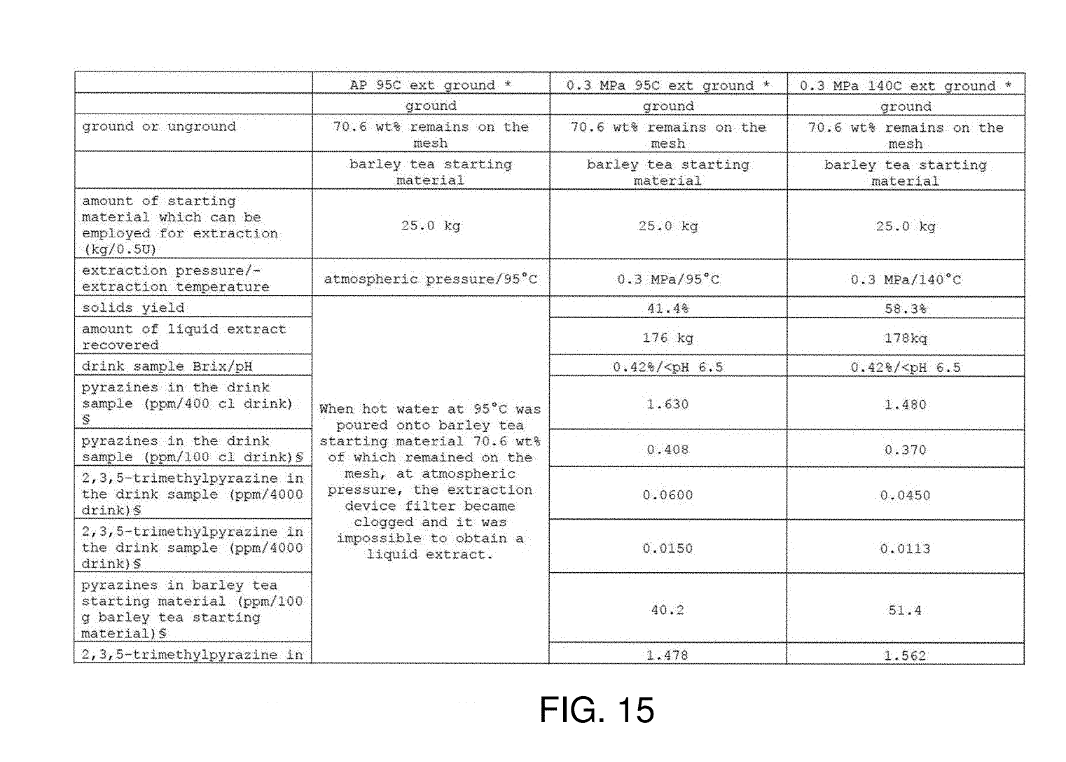

176 kg of liquid extract was obtained by pouring hot water at 95° C. onto 25.0 kg of ground barley tea starting material, at a pressure of 0.3 MPa in addition to atmospheric pressure. The liquid extract, with a solids yield of 41.4%, was diluted to give a Brix value of 0.42%, as a drinking sample. This drinking sample was further adjusted to pH 6.5, and then heat sterilized. When the drinking sample was distilled under conditions of outside temperature 40° C., decreased pressure 1.5×10-3 to 3.5×10−3 Pa, the resulting distillate was extracted with diethyl ether, dehydrated over sodium sulfate, and then the solvent was evaporated off at ambient pressure to prepare an aroma concentrate, and pyrazines were measured by GC-MS/FID (hydrogen flame ionization detector), as shown in FIG. 15, 1.630 ppm/400 g (0.408 ppm/100 g) was detected; 2,3,5-trimethylpyrazine was measured, and 0.060 ppm/400 g (0.015 ppm/100 g) was detected.

In order to convert these values to percentage recovery relative to barley tea starting material, the ppm of 2,3,5-trimethylpyrazine per 100 g of drinking sample was divided by the quantity (g) of barley tea starting material used per 100 g of drinking sample, and the result was multiplied by 100, and the quantity of pyrazines and the quantity of 2,3,5-trimethylpyrazine relative to the barley tea starting material was calculated. As a result, the quantity of pyrazines relative to barley tea starting material was 40.2 ppm/100 g (barley tea starting material), and the quantity of 2,3,5-trimethylpyrazine was 1.478 ppm/100 g (barley tea starting material).

In addition, 178 kg of liquid extract was obtained by pouring hot water at 140° C. onto 25.0 kg of barley tea starting material, at a pressure of 0.3 MPa in addition to atmospheric pressure. The solids yield in the resulting liquid extract was 58.3%. This liquid extract was diluted to give a Brix value of 0.42%, as a drinking sample. Moreover, this drinking sample was further adjusted to pH 6.5, and then heat sterilized. When the drinking sample was distilled under conditions of outside temperature 40° C., and decreased pressure 1.5×10-3 to 3.5×10−3 Pa, the resulting distillate was extracted with diethyl ether, dehydrated over sodium sulfate, and then the solvent was evaporated off at ambient pressure to prepare an aroma concentrate, and pyrazines were measured by GC-MS/FID, 1.480 ppm/400 g (0.370 ppm/100 g) is detected on measuring 2,3,5-trimethylpyrazine, 0.045 ppm/400 g (0.0113 ppm/100 g) was detected.

On converting these values to yield relative to barley tea starting material by the same process as above, pyrazines were 51.4 ppm/100 g (barley tea starting material), and 2,3,5-trimethylpyrazine was 1.562 ppm/100 g (barley tea starting material).

### OTHER EMBODIMENTS

The present invention has been described above by embodiments thereof; however, it should be understood that the descriptions above and the drawings, which are part of this disclosure do not limit the invention. Alternative embodiments, examples and operating techniques should be clear to a person skilled in the art from this disclosure. For example, in the first embodiment coffee beans are cited as an example of plant starting material, however, plants such as cocoa, black tea, green tea, oolong tea, and fruits, etc., can be employed as the plant starting material when producing a drink, etc. Thus it should be evident that the present invention also embraces various embodiments, etc., which have not been described here.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A process for producing tea, comprising extracting a liquid extract from a barley tea starting material under conditions of pressure, where at least 20 wt % of the barley tea starting material has a particle size of less than 1700 μm.

2. The process for producing tea as claimed in claim 1, wherein in extracting the liquid extract, a pressure of at least 0.03 MPa in addition to atmospheric pressure is applied inside an extraction device.

3. The process for producing tea as claimed in claim 1, wherein in extracting the liquid extract, a treatment liquid at 90° C. or more is poured onto the barley tea starting material.

4. The process for producing tea as claimed in claim 3, wherein in extracting the liquid extract, pressure is applied inside an extraction device such that the treatment liquid does not boil.

5. The process for producing tea as claimed in claim 1, wherein the tea produced is a barley tea or a blended tea.

6. The process for producing tea as claimed in claim 1, wherein the barley tea starting material comprises an unground barley tea starting material.

7. A process for producing a liquid extract including pyrazines, comprising extracting a liquid extract from barley under temperature conditions of at least 100° C., and in extracting the liquid extract, the liquid extract is extracted from the barley under conditions of pressure.

8. The process for producing a liquid extract including pyrazines as claimed in claim 7, wherein the barley comprises an unground barley.

9. The process for producing a liquid extract including pyrazines as claimed in claim 7, wherein in extracting the liquid extract, a treatment liquid at least at 100° C. is poured onto the barley.

10. The process for producing a liquid extract including pyrazines as claimed in claim 9, wherein in extracting the liquid extract, pressure is applied inside an extraction device such that the treatment liquid does not boil.

11. The process for producing a liquid extract including pyrazines as claimed in claim 7, wherein 2,3,5-trimethylpyrazine is extracted.

12. A process for producing a liquid extract, comprising extracting a liquid extract from a plant starting material under conditions of pressure, where at least 70 wt % of the plant starting material has a particle size of less than 1000 μm.

13. The process for producing a liquid extract as claimed in claim 12, wherein in extracting the liquid extract, a pressure of at least 0.03 MPa in addition to atmospheric pressure is applied inside an extraction device.

14. The process for producing a liquid extract as claimed in claim 12, wherein in extracting the liquid extract, a treatment liquid at 90° C. or more is poured onto the plant starting material.

15. The process for producing a liquid extract as claimed in claim 14, wherein in extracting the liquid extract, pressure is applied inside an extraction device such that the treatment liquid does not boil.

16. The process for producing a liquid extract as claimed in claim 12, wherein in extracting the liquid extract, a treatment liquid at no more than 60° C. is poured onto the plant starting material.

17. The process for producing a liquid extract as claimed in claim 12, wherein the plant starting material is coffee beans.

18. A process for producing coffee with reduced bitterness, comprising:
pouring a treatment liquid at no more than 60° C. onto coffee beans, under conditions of pressure, and
extracting a liquid extract from the coffee beans, and
at least 50 wt % of the coffee beans have a particle size of less than 1000 μm.

19. The process for producing coffee with reduced bitterness as claimed in claim 18, wherein at least 70 wt % of the coffee beans have a particle size of less than 1000 μm.

20. The process for producing coffee with reduced bitterness as claimed in claim 18, wherein in extracting the liquid extract, a treatment liquid at least at 20° C. and no more than 60° C. is poured onto the coffee beans.
